(19) United States
(12) Patent Application Publication
(10) Pub. No.: US 2026/0186823 A1
(43) Pub. Date: Jul. 2, 2026

(54) PROVIDING A PIPELINE FOR NEAR-REAL TIME ACCESS TO APPLICATION TRANSACTIONAL DATA

(71) Applicants: AT&T Intellectual Property I, L.P., Atlanta, GA (US); AT&T Communications Services India Private Limited, Bangalore (IN)

(72) Inventors: Soumya Paul, Kolkata (IN); Tapash Paul, Allen, TX (US)

(21) Appl. No.: 19/007,054

(22) Filed: Dec. 31, 2024

(51) Int. Cl. G06F 9/46; G06F 16/22

(52) U.S. Cl. CPC G06F 9/466; G06F 16/2282

(57) ABSTRACT

A method includes converting a plurality of files stored in a database that stores transactional data for a software application into a plurality of JavaScript object notation files, wherein the converting is performed as the plurality of files is loaded into the database, storing the plurality of JavaScript object notation files in a plurality of buckets, invoking a plurality of batch operations, wherein each batch operation of the plurality of batch operations reads a subset of the plurality of JavaScript object notation files from one bucket of the plurality of buckets with a defined frequency, reading the subset of the plurality of JavaScript object notation files into a tabular data structure, writing the tabular data structure into the one bucket in an open source, column-oriented data storage format, and reading the column-oriented data storage format into a query service that supports structured query language.

The present disclosure relates generally to data analytics, and relates more particularly to devices, non-transitory computer-readable media, and methods for providing a pipeline for near-real time access to application transactional data.

### BACKGROUND

On-demand cloud computing platforms and application programming interfaces (APIs) may use server farms to provide various services related to networking, compute, storage, middleware, Internet of Things (IoT), and other processing, as well as software tools. Customers of the on-demand cloud computing platforms and APIs may host their software applications with the on-demand cloud computing platforms in order to minimize the management, scaling, and/or patching of hardware and operating systems that must be performed by the customers. Under such an arrangement, the costs to the customers may be assessed based on usage, hardware, operating system, software, and selected networking features (which may offer varying degrees of availability, redundancy, security, and service). This provides customers with reliable access to large-scale computing capacity without the customers having to build their own dedicated server farms, which makes the on-demand cloud computing platforms an attractive and cost-effective solution for many enterprises.

### SUMMARY

In one example, the present disclosure describes a device, computer-readable medium, and method for providing a pipeline for near-real time access to application transactional data. For instance, in one example, a method performed by a processing system including at least one processor includes converting a plurality of files stored in a database that stores transactional data for a software application into a plurality of JavaScript object notation files, wherein the converting is performed as the plurality of files is loaded into the database, storing the plurality of JavaScript object notation files in a plurality of buckets, invoking a plurality of batch operations, wherein each batch operation of the plurality of batch operations reads a subset of the plurality of JavaScript object notation files from one bucket of the plurality of buckets with a defined frequency, reading the subset of the plurality of JavaScript object notation files into a tabular data structure, writing the tabular data structure into the one bucket in an open source, column-oriented data storage format, and reading the column-oriented data storage format into a query service that supports structured query language.

In another example, a non-transitory computer-readable medium stores instructions which, when executed by the processing system, cause the processing system to perform operations. The operations include converting a plurality of files stored in a database that stores transactional data for a software application into a plurality of JavaScript object notation files, wherein the converting is performed as the plurality of files is loaded into the database, storing the plurality of JavaScript object notation files in a plurality of buckets, invoking a plurality of batch operations, wherein each batch operation of the plurality of batch operations reads a subset of the plurality of JavaScript object notation files from one bucket of the plurality of buckets with a defined frequency, reading the subset of the plurality of JavaScript object notation files into a tabular data structure, writing the tabular data structure into the one bucket in an open source, column-oriented data storage format, and reading the column-oriented data storage format into a query service that supports structured query language.

In another example, a system includes a processing system including at least one processor and a non-transitory computer-readable medium storing instructions which, when executed by the processing system, cause the processing system to perform operations. The operations include converting a plurality of files stored in a database that stores transactional data for a software application into a plurality of JavaScript object notation files, wherein the converting is performed as the plurality of files is loaded into the database, storing the plurality of JavaScript object notation files in a plurality of buckets, invoking a plurality of batch operations, wherein each batch operation of the plurality of batch operations reads a subset of the plurality of JavaScript object notation files from one bucket of the plurality of buckets with a defined frequency, reading the subset of the plurality of JavaScript object notation files into a tabular data structure, writing the tabular data structure into the one bucket in an open source, column-oriented data storage format, and reading the column-oriented data storage format into a query service that supports structured query language.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for providing a pipeline for near-real time access to application transactional data may operate;

FIG. 2 illustrates a flowchart of an example method for providing a pipeline for near-real time access to application transactional data, according to examples of the present disclosure;

FIG. 3A, for instance, illustrates an example data structure that may be used to ensure that each JavaScript object notation file of a plurality of JavaScript object notation files in a database is read no more than once by a plurality of batch processes executed against the database;

FIG. 3B illustrates an updated version of the data structure of FIG. 3A in which the target path field has been updated to indicate that the listed files have been processed;

FIG. 4 illustrates a flowchart of an example method for providing a failover mechanism in a pipeline for near-real time access to application transactional data; and

FIG. 5 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium for providing a pipeline for near-real time access to application transactional data. As discussed above, on-demand cloud computing platforms and application programming interfaces (APIs) may use server farms to provide various services related to networking, compute, storage, middleware, Internet of Things (IoT), and other processing, as well as software tools. Customers of the on-demand cloud computing platforms and APIs may host their software applications with the on-demand cloud computing platforms in order to minimize the management, scaling, and/or patching of hardware and operating systems that must be performed by the customers. Under such an arrangement, the costs to the customers may be assessed based on usage, hardware, operating system, software, and selected networking features (which may offer varying degrees of availability, redundancy, security, and service). This provides customers with reliable access to large-scale computing capacity without the customers having to build their own dedicated server farms, which makes the on-demand cloud computing platforms an attractive and cost-effective solution for many enterprises.

One feature provided by an on-demand cloud computing platform may include storage of application transactional data in databases. In some on-demand cloud-computing platforms, these databases may include non-structured query language (NoSQL) databases which provide write-heavy unstructured storage. However, there are often tradeoffs when attempting to access the transactional data stored in these databases in near-real time for analytics purposes. For instance, existing solutions for real-time data access and delivery of data streams (to data lakes, data warehouses, analytics services, or the like) require data delivery streams to be maintained for each database table and require the data delivery streams to be always available, which makes these solutions costly from both a financial and resource consumption perspective. These solutions also typically fail to control duplicate injection (e.g., in the event that a data source gets reprocessed) or failover recovery mechanisms (e.g., in the event that the data delivery stream fails due to system unavailability, timeout errors, or the like). More cost effective query services tend to lack the ability to load data in real time or near-real time.

Examples of the present disclosure provide a pipeline that provides near-real time access to application transactional data in a cost effective manner. Further examples of the present disclosure minimize duplication of data in the event of data source reprocessing and provide failover recovery mechanisms to reprocess data files impacted by failures of the pipeline due to system unavailability or timeout errors.

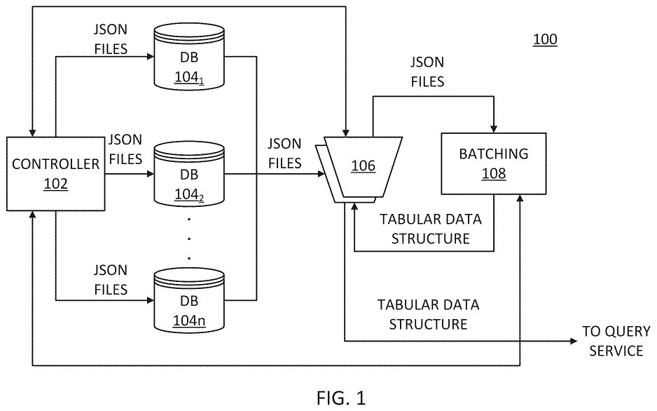

Within the context of the present disclosure providing “near-real time” access to data is understood to refer to providing access to data within minutes of the data being generated (as opposed to, for example, real time access, which would provide access within seconds of the data being generated). These and other aspects of the present disclosure are discussed in further detail with reference to FIGS. 1-5, below.

To further aid in understanding the present disclosure, FIG. 1 illustrates an example system 100 in which examples of the present disclosure for providing a pipeline for near-real time access to application transactional data may operate. In one example, the system may comprise or include all or part of a network monitoring and analysis system. The system 100 may be implemented within an on-demand cloud computing platform comprising a plurality of components controlled via instructions from a controller 102. In one example, the on-demand cloud computing platform may comprise an AMAZONE WEB SERVICES platform, or a similar platform.

The controller 102 may control operation of the other components of the system 100 as well as perform additional processing functions. The other components of the system 100 that are controlled by the controller 102 may include at least a plurality of databases (DBs) 104₁-104ₙ (hereinafter individually referred to as a “DB 104” or collectively referred to as “DBs 104”), buckets 106, and a batching engine 108.

In one example, the DBs 104 may contain transaction data for one or more software applications, where the transaction data may be stored in tabular form. For instance, the DBs 104 may comprise NoSQL databases. The DBs 104 may support data duplication and write-heavy, unstructured storage. Each DB 104 may comprise a single machine or a cluster of machines (where each machine in the cluster of machines is responsible for storing a partition or portion of the transactional data). In one example, the DBs 104 may comprise DYNAMO databases in accordance with an AMAZON WEB SERVICES platform. In one example, the controller 102 may convert (or may cause the DBs 104 to convert) files stored in the DBs 104 into JavaScipt object notation files as the files are loaded into the DBs 104.

In one example, the buckets 106 comprise containers for objects (where the objects may comprise, for instance, a plurality of the JavaScript object notation files, plus any metadata that describes the plurality of the JavaScript object notation files). For instance, in one example, the buckets may comprise AMAZON SIMPLY STORAGE SERVICE (S3) buckets. The controller 102 may store (or cause the buckets 106 to store) the plurality of JavaScript object notation files in one or more of buckets 106.

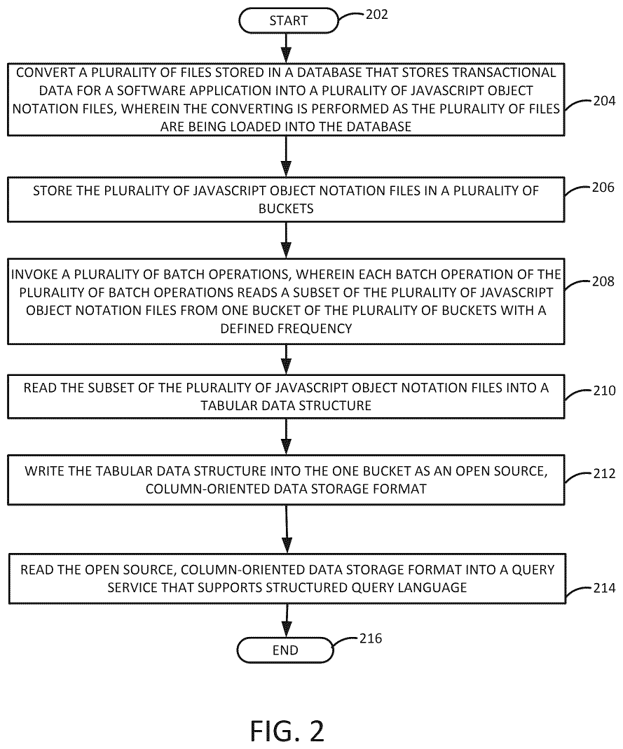

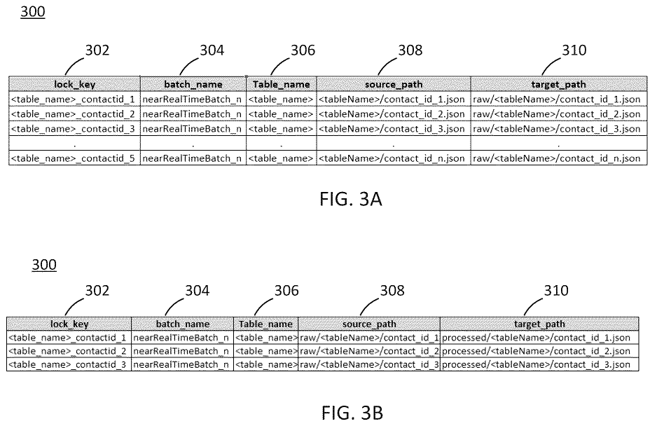

In one example, the batching engine 108 may comprise a machine or a program executed by a machine that performs batch operations on the JavaScript object notation files stored in the buckets 106. For instance, the batching engine 108 may perform near-real time batch operations, which may be repeated with a defined frequency (e.g., every x minutes). In one example, the controller 102 and/or the batching engine 108 may maintain and update a data structure that tracks the JavaScript object notation files that the batching engine 108 reads from the buckets 106. Details of one example of these data structures are described in greater detail in connection with FIGS. 2 and 3A.

The JavaScript object notation files read by the batching engine 108 may also be read into a tabular data structure (e.g., by the controller 102 and/or the batching engine 108). This tabular data structure, in turn, may be written back into one of the buckets 106 in an open-source, column-oriented format (such as the APACHE PARQUET format). One example of this tabular data structure is described in greater detail below in connection with FIG. 3B. This tabular data format may, in turn, be read into a query service that supports SQL, such as the AMAZON WEB SERVICES ATHENA service.

For instance, an example method for a providing a pipeline for near-real time access to application transactional data is discussed in further detail below in connection with FIG. 2.

It should be noted that the system 100 has been simplified. Thus, those skilled in the art will realize that the system 100 may be implemented in a different form than that which is illustrated in FIG. 1, or may be expanded by including additional devices or connections without altering the scope of the present disclosure. In addition, system 100 may be altered to omit various elements, substitute elements for devices that perform the same or similar functions, combine elements that are illustrated as separate devices, and/or elements as functions that are spread across several devices that operate collectively as the respective elements. Thus, these and other modifications are all contemplated within the scope of the present disclosure.

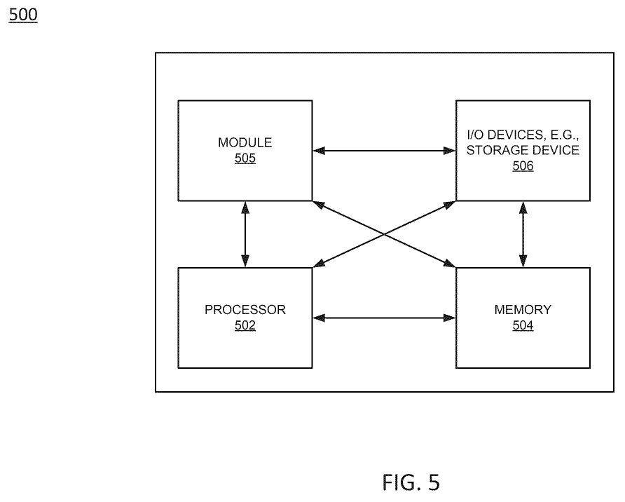

To further aid in understanding the present disclosure, FIG. 2 illustrates a flowchart of an example method 200 for providing a pipeline for near-real time access to application transactional data. In one example, the method 200 may be performed by the controller 102, by the controller 102 in cooperation with, or by another element of the system 100 illustrated in FIG. 1. However, in other examples, the method 200 may be performed by another device, such as the computing system 500 of FIG. 5, discussed in further detail below. For the sake of discussion, the method 200 is described below as being performed by a processing system (where the processing system may comprise a component of the controller 102 or another element of the system 100, the computing system 500, or another device).

The method 200 begins in step 202. In step 204, the processing system may convert a plurality of files stored in a database that stores transactional data for a software application into a plurality of JavaScript object notation files, wherein the converting is performed as the plurality of files is loaded into the database.

In one example, the database may be a high-performance (e.g., capable of serving over ten trillion requests per day, or peaks of twenty million requests per second) NoSQL database that supports duplication of data. For instance, the database may function as a key-value store, or a hash-map backed by persistent storage. The database may comprise a cluster of machines, where each machine of the cluster of machines is responsible for storing a partition or portion of the transactional data in the machine's local disks. Each machine in the cluster may be assigned a random integer value, and each machine in the cluster may know the random integer values assigned to all of the other machines in the cluster. In one example, the database may comprise an AMAZON WEB SERVICES DYNAMO database that provide write-heavy, unstructured database storage.

In one example, the converting is performed as the plurality of files is being loaded into the database via a loading process. The loading process may load the plurality of files directly from the software application into the database. In one example, the process of converting the plurality of files into a plurality of JSON files may use the same table load dictionary that is used to load the plurality of files into the database.

In step 206, the processing system may store the plurality of JavaScript object notation files in a plurality of buckets. In one example, each bucket of the plurality of buckets may comprise a container for objects (where each object may comprise a file of the plurality of JSON files, plus any metadata that describes the file). For instance, in one example, each bucket may comprise an AMAZON WEB SERVICES S3 bucket. Each object stored within a bucket may be assigned an identifier or key that is unique within the bucket.

A bucket may allow for the storage of multiple versions of the same object within the bucket. A bucket may also be associated with specific access controls designed to manage access to the bucket by individuals and applications.

In step 208, the processing system may invoke a plurality of batch operations, wherein each batch operation of the plurality of batch operations reads a subset of the plurality of JavaScript object notation files from one bucket of the plurality of buckets with a defined frequency.

In one example, the plurality of batch operations may comprise near-real time batch operations (e.g., batch operations that are performed within minutes of the plurality of JSON files being stored in the plurality of buckets). In one example, each batch operation of the plurality of batch operations may be repeated with the defined frequency. For instance, each batch operation may be repeated every x minutes (where the value of x may be configurable depending on resource availability, urgency of data access, or other factors).

In one example, invoking the plurality of batch operations in step 208 may include taking measures to minimize the chances of separate batch operations of the plurality of batch operations reading the same file of the plurality of JSON files. For instance, if a first batch operation performed on a subset of the plurality of JSON files takes a long time to run, then the first batch operation may not be complete for all files of the subset of the plurality of JSON files by the time a next batch operation is initiated; thus, the next batch operation may attempt to include some of the files for which the first batch operation has not yet completed in the next subset of the plurality of JSON files. If both the first and next batch operations read the same file(s) of the plurality of JSON files, then this may result in the method 200 producing duplicate results, which unnecessarily consumes resources. In one example, the method 200 may minimize the chances of two batch operations reading the same JSON file by updating a data structure each time a batch operation of the plurality of batch operations is initiated.

FIG. 3A, for instance, illustrates an example data structure 300 that may be used to ensure that each JavaScript object notation file of a plurality of JavaScript object notation files in a database is read no more than once by a plurality of batch operations executed against the database. The data structure 300 may be used to effectively lock JSON files of the plurality of JSON files once those JSON files are read by a batch operation, so that no subsequently initiated batch operations can read those JSON files.

In one example, the data structure 300 may include an entry for each JSON file of the plurality of JSON files. The entry for a JSON file may comprise a plurality of fields, including at least: a lock key (lock_key) field 302, a batch name (batch_name) field 304, a table name (table_name) field 306, a source path field (source_path) 308, and a target path (target_path) field 310. The lock key field 302 may identify the file name for the JSON file, the batch name field 304 may identify the name of the batch operation to which the JSON files belongs (e.g., the batch operation that has already read or is in the process of reading the JSON file), and the table name field 306 may identify the name of the table in the database from which the JSON file was read. When the lock key field 302, batch name field 304, and the table name field 306 of the same entry all contain data, this indicates that the JSON file corresponding to the entry has already been selected by a batch operation of the plurality of batch operations, and that a PUT operation attempted by any other batch operation(s) for the JSON file (which may specify the lock key in the lock key field 302) should fail. Failure of the PUT operation may cause the other batch operation(s) to update the PUT operation to remove the lock key for the JSON file.

In further examples, the plurality of fields in the entry for a JSON file may further include a source path (source_path) field 308 and a target path (target_path) field 310. These fields may function to move JSON files that belong to a previously initiated and/or ongoing batch operation (JSON files that have already been read or are in the process of being read) out of the landing zone folder of a bucket (the source path) to a different folder of the bucket (the target path, e.g., in one example, a folder called “Raw”). According to conventional batch operations, a JSON file may remain in the landing zone folder until a batch operation has completed processing of the JSON file. Because batch operations will typically retrieve JSON files from the landing zone folder, a batch operation may attempt to retrieve a JSON file from the landing zone that has already been retrieved by a previous batch operation that has not yet completed. As discussed above, the use of the lock key field 302, batch name field 304, and table name field 306 will minimize the chance of the subsequent batch operation successfully retrieving the JSON file. However, by moving the JSON file out of the landing zone folder once the JSON file is retrieved by the previous batch operation, the subsequent batch operation can be prevented from attempting to retrieve the JSON file in the first place, thereby conserving time and computing resources.

When a batch operation reads a JSON file from a bucket, the JSON file may be read from the Raw folder rather than the landing zone folder. In this example, once a JSON file is retrieved by a batch operation, the JSON file will be moved from the landing zone folder to the Raw folder before the JSON file is read by the batch operation.

In step 210, the processing system may read the subset of the plurality of JavaScript object notation files into a tabular data structure. In one example, the tabular data structure may comprise a plurality of rows and a plurality of columns, where each intersection of row and column stores a data value associated with a JSON file of the plurality of JSON files (e.g., similar to an SQL table or a spreadsheet). In one example, the tabular data structure may support both functional-style operations (e.g., map, reduce, filter, and the like) and SQL operations (e.g., select, project, aggregate, and the like). Thus, the tabular data structure may require a schema to be specified before the subset of the plurality of JSON files can be loaded. For instance, in one example, the tabular data structure may comprise a dataframe.

In step 212, the processing system may write the tabular data structure into the one bucket in an open source, column-oriented data storage format.

In one example, the values in each column of the column-oriented data storage format are stored in contiguous memory locations. For instance, in one example, the open source, column-oriented data storage format may be the APACHE PARQUET format. The APACHE PARQUET format operates well with complex data in large volumes and is known for its both performant data compression and its ability to handle a wide variety of encoding types. Queries can fetch specific column values without reading full row data.

In one example, writing the tabular data structure into the one bucket in step 212 may include writing the tabula data structure with a year/month/day partition.

In a further example, writing the tabular data structure in the open source column-oriented data storage format includes creating a metadata file for the open source, column-oriented data storage format file that is created. The metadata file may comprise two mappings: a first mapping that maps each file name associated with each JSON file in the subset of the plurality of JSON files to the open source, column-oriented data storage format file and a second mapping that maps the open source, column-oriented data storage format file to all of the JSON files in the subset of the plurality of JSON files (because while a JSON file should only be associated with one open source, column-oriented data storage format file, an open source, column-oriented storage format file may be associated with a plurality of JSON files). The metadata file may be stored in the one bucket along with the open source, column-oriented storage format file.

The metadata file may help to minimize the duplication of files when JSON files which have already been processed by a batch operation are reprocessed by subsequent batch operations that retrieved the JSON files from the landing zones of their respective buckets. As discussed above, steps may be taken to minimize the reprocessing of individual JSON files (e.g., using the data structure 300 illustrated in FIG. 3A). However, in some cases, some JSON files may still be reprocessed. The metadata file may help to filter redundant results from the open source, column-oriented storage format files.

In one example, the processing system may check the metadata file between steps 208 and step 210 during subsequent iterations of the method 200. For instance, once the subset of the plurality of JSON files have been moved to the Raw folder, each JSON file in the subset of the plurality of JSON files may be checked to see whether the each JSON file is mapped to an open source, column-oriented storage format file (e.g., according to a first mapping). If a JSON file is mapped to an open source, column-oriented storage format file, this may indicate that the JSON file has already been processed.

Moreover, if a JSON file is mapped to an open source, column-oriented storage format file, then a second mapping may be checked to identify all JSON files which are mapped to the open source, column-oriented format file (and which have, therefore, also already been processed). In one example, the entire open source, column-oriented format file may be deleted at this stage, and all the subset of the plurality of JSON files may be moved to a new “Processed” folder in the one bucket for JSON files that have completed processing. In a further example, the data structure 300 illustrated in FIG. 3A may be updated to indicate that the subset of the plurality of JSON files has been processed.

FIG. 3B, for instance, illustrates an updated version of the data structure 300 of FIG. 3A in which the target path field 310 has been updated to indicate that the listed files have been processed. As illustrated in FIG. 3B, the target path (target_path) field 310 has been updated to indicate that the listed files have been moved to the Processed folder.

In step 214, the processing system may read the column-oriented data storage format into a query service that supports structured query language. In one example, the column-oriented data storage format may be read into the query service using a crawler that creates the metadata. The metadata created by the crawler may allow other services, such as the query service, to view the column-oriented data storage format as a database with tables. In one example, the query service may comprise the AMAZON WEB SERVICES ATHENA service. In step 216, the method 200 may end.

By reading the column-oriented data storage format into the query service, this may make it possible to analyze the transactional data directly through the query service, using standard SQL, in near real time. The ability to analyze the transactional data using standard SQL is much more cost effective than current solutions for providing real time access to transactional data.

Further examples of the present disclosure may make use of the data structure 300 of FIGS. 3A and 3B to provide a failover mechanism in the event that any of the batch operations invoked in step 208 of the method 200 should fail.

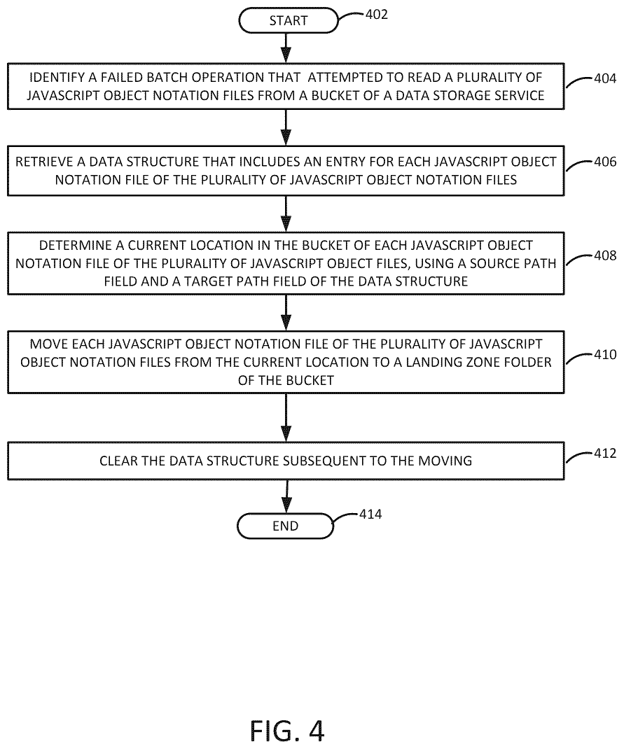

FIG. 4 illustrates a flowchart of an example method 400 for providing a failover mechanism in a pipeline for near-real time access to application transactional data. In one example, the method 400 may be performed by the controller 102 or by another element of the system 100 illustrated in FIG. 1. However, in other examples, the method 400 may be performed by another device, such as the computing system 500 of FIG. 5, discussed in further detail below. For the sake of discussion, the method 400 is described below as being performed by a processing system (where the processing system may comprise a component of the controller 102 or another element of the system 100, the computing system 500, or another device).

The method 400 begins in step 402. In step 404, the processing system may identify a failed batch operation that attempted to read a plurality of JavaScript object notation files from a bucket of a data storage service.

In one example, the failed batch operation may be one of the plurality of batch operations invoked in step 208 of the method 200. In one example, a batch operation may be considered to have failed if the batch operation is determined to have been processing for at least a threshold period of time (e.g., two hours) without having been completed.

In step 406, the processing system may retrieve a data structure that includes an entry for each JavaScript object notation file of the plurality of JavaScript object notation files. In one example, the data structure may be the data structure 300 illustrated in FIGS. 3A and 3B. Thus, the data structure may include a plurality of fields, including a source path field 308 and a target path field 310. The data structure may be stored in the bucket in which the plurality of JSON files is stored.

In step 408, the processing system may determine a current location in the bucket of each JavaScript object notation file of the plurality of JavaScript object notation files, using a source path field and a target path field of the data structure.

The source path field and the target path field indicate where each JSON file of the plurality of JSON files came from, and where each JSON file is intended to go. Thus, the source path field and the target path field may indicate possible current locations for the corresponding JSON file.

For instance, if the source path field indicates the landing zone folder of the bucket and the target path field indicates the Raw folder, then the current location of the corresponding JSON file is likely either the landing zone folder or the Raw folder. If the source path field indicates the Processed folder and the target path field is empty, then the current location of the corresponding JSON file is likely the Processed folder. If the source path field indicates the Raw folder of the bucket and the target path field indicates the Processed folder, then the current location of the corresponding JSON file is likely either the Raw folder or the Processed folder. If the source path field indicates the Processed folder of the bucket and the target path field indicates the Processed folder, then the current location of the corresponding JSON file is likely the Processed folder.

In step 410, the processing system may move the each JavaScript object notation file of the plurality of JavaScript object notation files from the current location to a landing zone folder of the bucket.

In one example, if the current location of a JSON file is the landing zone folder, then the JSON file does not need to be moved. However, if the current location of the JSON file is the Raw folder or the Processed folder, then the JSON file may be moved to the landing zone folder.

If the target path field indicates a column-oriented data storage format file, then the column-oriented data storage format file may be scanned for file names (e.g., lock_keys) of the JSON files contained in the column-oriented data storage format file, and those JSON files may be moved from the Raw folder to the landing zone folder.

In step 412, the processing system may clear the data structure subsequent to the moving. In one example, clearing the data structure may comprise deleting the data structure. In another example, clearing the data structure may comprise resetting the source path field 308 and the target path field 310 of the data structure (e.g., so that the source path field indicates the landing zone folder). The method 400 may end in step 414.

Although not expressly specified above, one or more steps of the method 200 or the method 400 may include a storing, displaying, and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 4 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

FIG. 5 depicts a high-level block diagram of a computing device specifically programmed to perform the functions described herein. For example, any one or more components or devices illustrated in FIG. 1 or described in connection with the method 200 or the method 400 may be implemented as the system 500. For instance, any one or more of the controller 102 or DBs 104 of FIG. 1 (such as might be used to perform the method 200 or the method 400) could be implemented as illustrated in FIG. 5. As depicted in FIG. 5, the system 500 comprises a hardware processor element 502, a memory 504, a module 505 for providing a pipeline for near-real time access to application transactional data, and various input/output (I/O) devices 506.

The hardware processor 502 may comprise, for example, a microprocessor, a central processing unit (CPU), or the like. The memory 504 may comprise, for example, random access memory (RAM), read only memory (ROM), a disk drive, an optical drive, a magnetic drive, and/or a Universal Serial Bus (USB) drive. The module 505 for providing a pipeline for near-real time access to application transactional data may include circuitry and/or logic for processing and moving application transactional data within a data storage system. The input/output devices 506 may include, for example, storage devices (including but not limited to, a tape drive, a floppy drive, a hard disk drive or a compact disk drive), a receiver, a transmitter, a fiber optic communications line, an output port, or a user input device (such as a keyboard, a keypad, a mouse, and the like).

Although only one processor element is shown, it should be noted that the computer may employ a plurality of processor elements. Furthermore, although only one specific-purpose computer is shown in the Figure, if the method(s) as discussed above is implemented in a distributed or parallel manner for a particular illustrative example, i.e., the steps of the above method(s) or the entire method(s) are implemented across multiple or parallel specific-purpose computers, then the specific-purpose computer of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for providing a pipeline for near-real time access to application transactional data can be loaded into memory 504 and executed by hardware processor element 502 to implement the steps, functions or operations as discussed above in connection with the example method 200 or the example method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for providing a pipeline for near-real time access to application transactional data (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
converting, by a processing system including at least one processor, a plurality of files stored in a database that stores transactional data for a software application into a plurality of javascript object notation files, wherein the converting is performed as the plurality of files is loaded into the database;
storing, by the processing system, the plurality of javascript object notation files in a plurality of buckets;
invoking, by the processing system, a plurality of batch operations, wherein each batch operation of the plurality of batch operations reads a subset of the plurality of javascript object notation files from one bucket of the plurality of buckets with a defined frequency;
reading, by the processing system, the subset of the plurality of javascript object notation files into a tabular data structure;
writing, by the processing system, the tabular data structure into the one bucket in an open source, column-oriented data storage format; and
reading, by the processing system, the column-oriented data storage format into a query service that supports structured query language.

2. The method of claim 1, wherein the database comprises a non-structured query language database.

3. The method of claim 1, wherein the converting uses a same table load dictionary that is used to load the plurality of files into the database.

4. The method of claim 1, wherein each bucket of the plurality of buckets comprises a container for objects, and wherein each object comprises a file of the plurality of javascript object notation files, plus metadata that describes the file.

5. The method of claim 1, wherein the plurality of batch operations comprises a plurality of near-real time batch operations.

6. The method of claim 1, wherein each batch operation of the plurality of batch operations is repeated with the defined frequency.

7. The method of claim 1, wherein the invoking comprises updating a data structure each time a batch operation of the plurality of batch operations is initiated.

8. The method of claim 7, wherein the data structure include an entry for each javascript object notation file of the plurality of javascript object notation files, and the entry includes a plurality of fields, including at least: a lock key field, a batch name field, a table name field, a source path field, and a target path field.

9. The method of claim 8, wherein when the lock key field, the batch name field, and the table name field of an entry all contain data, this indicates that the each javascript object notation file has already been selected by a batch operation of the plurality of batch operations, and that a put operation attempted by any other batch operation of the plurality of batch operations for the javascript object notation file should fail.

10. The method of claim 8, wherein the plurality of fields further includes a source path field and a target path field.

11. The method of claim 10, wherein the source path field and the target path field each indicate a folder of the one bucket.

12. The method of claim 1, wherein values in each column of the column-oriented data storage format are stored in contiguous memory locations.

13. The method of claim 1, wherein the writing the tabular data structure into the one bucket includes writing the tabula data structure with a year/month/day partition.

14. The method of claim 1, wherein the column-oriented data storage format is read into the query service using a crawler that creates metadata.

15. The method of claim 1, further comprising:
identifying, by the processing system, a failed batch operation of the plurality of batch operations;
retrieving, by the processing system, a data structure that includes an entry for each javascript object notation file of the plurality of javascript object notation files that is stored in a bucket of the plurality of buckets read by the failed batch operation;
determining, by the processing system, a current location of the each javascript object notation file in the bucket of the plurality of buckets, using a source path field and a target path field of the data structure;
moving, by the processing system, the each javascript object notation file from the current location to a landing zone folder of the bucket of the plurality of buckets; and
clearing, by the processing system, the data structure subsequent to the moving.

16. A non-transitory computer-readable medium storing instructions which, when executed by a processing system including at least one processor, cause the processing system to perform operations, the operations comprising:
converting a plurality of files stored in a database that stores transactional data for a software application into a plurality of javascript object notation files, wherein the converting is performed as the plurality of files is loaded into the database;
storing the plurality of javascript object notation files in a plurality of buckets;
invoking a plurality of batch operations, wherein each batch operation of the plurality of batch operations reads a subset of the plurality of javascript object notation files from one bucket of the plurality of buckets with a defined frequency;
reading the subset of the plurality of javascript object notation files into a tabular data structure;
writing the tabular data structure into the one bucket in an open source, column-oriented data storage format; and
reading the column-oriented data storage format into a query service that supports structured query language.

17. The non-transitory computer-readable medium of claim 16, wherein the database comprises a non-structured query language database.

18. The non-transitory computer-readable medium of claim 16, wherein the converting uses a same table load dictionary that is used to load the plurality of files into the database.

19. The non-transitory computer-readable medium of claim 16 wherein the column-oriented data storage format is read into the query service using a crawler that creates metadata.

20. A system comprising:
a processing system including at least one processor; and
a non-transitory computer-readable medium storing instructions which, when executed by the processing system, cause the processing system to perform operations, the operations comprising:
converting a plurality of files stored in a database that stores transactional data for a software application into a plurality of javascript object notation files, wherein the converting is performed as the plurality of files is loaded into the database;
storing the plurality of javascript object notation files in a plurality of buckets;
invoking a plurality of batch operations, wherein each batch operation of the plurality of batch operations reads a subset of the plurality of javascript object notation files from one bucket of the plurality of buckets with a defined frequency;
reading the subset of the plurality of javascript object notation files into a tabular data structure;
writing the tabular data structure into the one bucket in an open source, column-oriented data storage format; and
reading the column-oriented data storage format into a query service that supports structured query language.
